(19) United States
(12) Patent Application Publication
(10) Pub. No.: US 2020/0004929 A1
(43) Pub. Date: Jan. 2, 2020

(54) PLATFORM-IN-PLATFORM CONTENT DISTRIBUTION

(71) Applicant: Korea Content Platform, LLC, Los Angeles, CA (US)

(72) Inventors: Kunhee Park, Los Angeles, CA (US); Seokki Park, Los Angeles, CA (US); Jongse Yoon, Seoul (KR); Jaehwang Im, Seoul (KR); Chul Kwon, Seoul (KR); Jisun Yoo, Seoul (KR)

(21) Appl. No.: 16/453,777

(22) Filed: Jun. 26, 2019

Related U.S. Application Data
(60) Provisional application No. 62/692,224, filed on Jun. 29, 2018.

(51) Int. Cl. G06F 21/10; H04L 29/06

(52) U.S. Cl. CPC G06F 21/10; G06F 2221/0713; H04L 63/0853

(57) ABSTRACT

A platform-in-platform (PIP) system allows for the access of multimedia content from different platforms on a single platform. The PIP system includes a first content platform configured to operate a PIP front-end module; a PIP back-end module configured to authenticate a user according to a user credential and to generate a session token in response to authenticating the user; and a content delivery back-end module configured to store multimedia content not available via the first content platform. The PIP front-end module is configured to provide a user credential to the

PIP back-end module, to receive the session token, and to provide the session token to the content delivery back-end module. The content delivery back-end module is configured to verify the session token and to provide access to the multimedia content to the PIP front-end module.

### CROSS-REFERENCE TO RELATED APPLICATION

The present application claims priority to and the benefit of Provisional Application No. 62/692,224, filed on Jun. 29, 2018, entitled “PLATFORM IN PLATFORM CONTENT DISTRIBUTION”, the entire content of which is incorporated herein by reference.

### BACKGROUND

### 1. Field

One or more aspects of embodiments disclosed herein relate to a system and method for a digital content distribution platform.

### 2. Description of Related Art

Multimedia content delivery platforms have become common systems for distributing videos and audio to wide audiences. Most content platforms include a variety of multimedia content that is often exclusive to the platform. Thus, users often subscribe to multiple platforms to access all of the content that they are interested in. Using multiple platforms can create a cumbersome user experience. For example, the user may be required to register with each platform and provide personal and billing information. After registration, a user may have to visit a website or run an application and login to browse, search, and view content. If the user does not find any desired content on the first content platform, then the process may have to be repeated multiple times.

A user may have to access multiple viewing devices to find and consume content. For example, smart televisions, personal computers, smartphones, tablet computers, and streaming devices connected to regular televisions are all used to find and play content. Depending on the electronic device, the user may be required to utilize a web browser or a dedicated application to access each content provider. Thus searching and viewing content may involve using multiple applications and, in some cases, multiple devices, adding needless complication to the user experience.

The above information disclosed in this Background section is only for enhancement of understanding of the background and therefore it may contain information that does not constitute prior art.

### SUMMARY

Aspects of embodiments of the present invention relate to a system and method for platform-in-platform content distribution.

In various embodiments, the platform-in-platform (PIP) system includes: a first content platform configured to operate a PIP front-end module; a PIP back-end module configured to authenticate a user according to a user credential and to generate a session token in response to authenticating the user; and a content delivery back-end module configured to store multimedia content not available via the first content platform, wherein: the PIP front-end module is configured to provide a user credential to the PIP back-end module, to receive the session token, and to provide the session token to the content delivery back-end module; and the content delivery back-end module is configured to verify the session token and to allow access to the multimedia content to the PIP front-end module.

In various embodiments, the PIP front-end module further includes a player configured to play the multimedia content.

In various embodiments, the PIP back-end module includes a user database, wherein the generation of the session token is logged in the user database and wherein the content delivery back-end is configured to verify the session token by validating the session token with the session token stored in the user database.

In various embodiments, the content delivery back-end further comprises an over-the-top media services (OTT) module configured to control the storage and distribution of the multimedia content.

In various embodiments, the PIP front-end is configured to send and receive data with the OTT module according to an OTT application programming interface (API).

In various embodiments, the PIP back-end further includes an API abstraction layer configured to provide an interface between the OTT module and the PIP front-end.

In various embodiments, the content delivery back-end module further includes an analytics module configured to receive data associated with the consumption of the multimedia content on the player.

In various embodiments, the PIP back-end module further includes an analytics abstraction layer configured to provide an interface between the analytics module and the player.

In various embodiments, a method of providing multimedia content using a platform-in-platform (PIP) system includes: requesting, by a PIP back-end module, a user credential; providing, by a PIP front-end module, the user credential; validating, by the PIP back-end module, the user credential; providing, by the PIP back-end module, a session token to the PIP front-end module; providing, by the PIP front-end module, the session token to a content delivery back-end module; and receiving, by the PIP front-end module, a multimedia content from the content delivery back-end module.

In various embodiments, the method further includes requesting, by the PIP front-end module, user validation for access to the content delivery back-end module.

In various embodiments, verifying the authenticity of the session token includes validating the session token with the PIP back-end module.

In various embodiments, the PIP front-end module is configured to operate on a first platform and the content delivery back-end is configured to supply multimedia content from a second platform.

In various embodiments, the multimedia content is not available on the first platform without the use of the PIP front-end.

In various embodiments, the PIP front-end module further includes a player configured to play the multimedia content.

In various embodiments, the content delivery back-end further includes an over-the-top media services (OTT) module configured to control the storage and distribution of the multimedia content, and the method further includes sending and receiving data, by the player to the OTT module, according to an application programming interface (API) of the OTT module.

In various embodiments, the PIP backend further includes an API abstraction layer and the content delivery back-end further includes an over-the-top media services (OTT) module configured to control the storage and distribution of the multimedia content, wherein the method further includes sending and receiving data, by the player, to the OTT module using the API abstraction layer.

In various embodiments, the content delivery back-end module further includes an analytics module, and the PIP back-end module further includes an analytics abstraction layer, wherein the method further includes sending analytics information from the player to the analytics module using the analytics abstraction layer.

In various embodiments, the method further includes verifying, by the content delivery back-end module, an authenticity of the session token.

In various embodiments, the PIP system includes: a PIP front-end module configured to operate on a first platform, wherein the first platform is configured to provide access to first multimedia content; a PIP back-end module configured to authenticate a user according to a user credential, to generate a session token in response to authenticating the user, and to provide the session token to the PIP front-end module; and a content delivery back-end module configured to provide access to second multimedia content associated with a second platform, wherein: the PIP front-end module is configured to access and play the second multimedia content by providing the session token to the content delivery back-end module.

In various embodiments, the the PIP front-end module is further configured to provide a user credential to the PIP back-end module and to receive the session token.

In various embodiments, the content delivery back-end module is configured to provide access to the second multimedia content by the PIP front-end module when the session token is validated by the PIP back-end module.

### BRIEF DESCRIPTION OF THE DRAWINGS

Some embodiments can be understood in more detail from the following description taken in conjunction with the accompanying drawings, of which:

FIG. 1A is an example PIP system according to various embodiments of the present invention;

FIG. 1B is an example system architecture of a PIP system according to various embodiments of the present invention;

FIG. 1C depicts a PIP system architecture including multiple content platforms according to various embodiments of the present invention;

FIG. 2 is an example system architecture of a PIP system according to various embodiments of the present invention;

FIG. 3 is an example method of a PIP playback according to various embodiments of the present invention;

FIG. 4 is an example method of registering for a PIP system according to various embodiments of the present invention;

FIG. 5 is an example system architecture of a PIP system with analytics according to various embodiments of the present invention;

FIG. 6 is an example system architecture of a PIP system with a PIP back-end having an API abstraction layer according to various embodiments of the present invention;

FIG. 7 is an example system architecture of a PIP system with a PIP back-end having an API abstraction layer and analytics abstraction layer according to various embodiments of the present invention.

### DETAILED DESCRIPTION

Hereinafter, example embodiments will be described in more detail with reference to the accompanying drawings, in which like reference numbers refer to like elements throughout. The present invention, however, may be embodied in various different forms, and should not be construed as being limited to only the illustrated embodiments herein. Rather, these embodiments are provided as examples so that this disclosure will be thorough and complete, and will fully convey the aspects and features of the present invention to those skilled in the art. Accordingly, processes, elements, and techniques that are not necessary to those having ordinary skill in the art for a complete understanding of the aspects and features of the present invention may not be described. Unless otherwise noted, like reference numerals denote like elements throughout the attached drawings and the written description, and thus, descriptions thereof will not be repeated. In the drawings, the relative sizes of elements, layers, and regions may be exaggerated for clarity.

It will be understood that, although the terms “first,” “second,” “third,” etc., may be used herein to describe various elements, components, and/or sections, these elements, components, and/or sections should not be limited by these terms. These terms are used to distinguish one element, component, or section from another element, component, or section. Thus, a first element, component, or region, described below could be termed a second element, component, or region, without departing from the spirit and scope of the present invention.

It will be understood that when an element or component is referred to as being “in communication with,” “connected to,” or “coupled to” another element or component, it can be directly in communication with, connected to, or coupled to the other element or component, or one or more intervening elements may be present. In addition, it will also be understood that when an element or component is referred to as being “between” two elements or components, it can be the only element or component between the two elements or components, or one or more intervening elements or components may also be present.

The terminology used herein is for the purpose of describing particular embodiments only and is not intended to be limiting of the present invention. As used herein, the singular forms “a” and “an” are intended to include the plural forms as well, unless the context clearly indicates otherwise. It will be further understood that the terms “comprises,” “comprising,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively. Also, the term “exemplary” is intended to refer to an example or illustration.

The electronic or electric devices and/or any other relevant devices or components according to embodiments of the present invention described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be may be a process or thread, running on one or more processors, in one or more computing devices, executing computer program instructions and interacting with other system components for performing the various functionalities described herein. The computer program instructions are stored in a memory that may be implemented in a computing device using a standard memory device, such as, for example, a random access memory (RAM). The computer program instructions may also be stored in other non-transitory computer readable media such as, for example, a flash drive, or the like. Also, a person of skill in the art should recognize that the functionality of various computing devices may be combined or integrated into a single computing device, or the functionality of a particular computing device may be distributed across one or more other computing devices without departing from the spirit and scope of the exemplary embodiments of the present invention.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

In various embodiments a platform in platform (PIP) content distribution system is configured to provide access to multimedia content from multiple content platforms while interacting with a single platform. The PIP content distribution system may also be configured to allow for a user to easily access content from multiple provider platforms using a single platform operating on any of his/her electronic devices. In various embodiments, the PIP content distribution system allows the user to use a single platform to subscribe and access one or more different platforms. In various embodiments, the PIP content distribution system allows a user to utilize a single login system to access the various platforms and a single registration and billing system to subscribe and maintain a user's subscription(s). For example, the user may login to a platform that is a part of the PIP content distribution system and may then access content from the platform as well as content from one or more other content platforms that are also part of the PIP content distribution system. Thus, a user's experience may be improved because the user is able to access and operate multiple platforms from a single platform and have a uniform experience across multiple content and device platforms.

In various embodiments, a user may use an electronic device to access the PIP content distribution system. The electronic device may be a computer, a smartphone, a tablet, a smart tv, or other suitable electronic device capable of streaming multimedia content (e.g., a set-top box, Roku® (Roku® is a registered trademark of Roku Technologies Corporation, a Delaware corporation), Amazon Fire® (Amazon Fire® is a registered trademark of Amazon Technologies, Inc., a Nevada Corporation), Google Chromecast® (Google Chromecast® is a registered trademark of Google LLC, a Deleware Limited Liability Company), Apple TV® (Apple TV is a registered trademark of Apple, Inc., a California Corporation), etc.). In various embodiments, a player may be accessed on the electronic device. For example, in some embodiments the player may be a web browser-based player for streaming multimedia files to a computer, while in other embodiments, the player may be accessed using a dedicated application that is launched on the electronic device (e.g., an Android® application, an iOS® application, or other application).

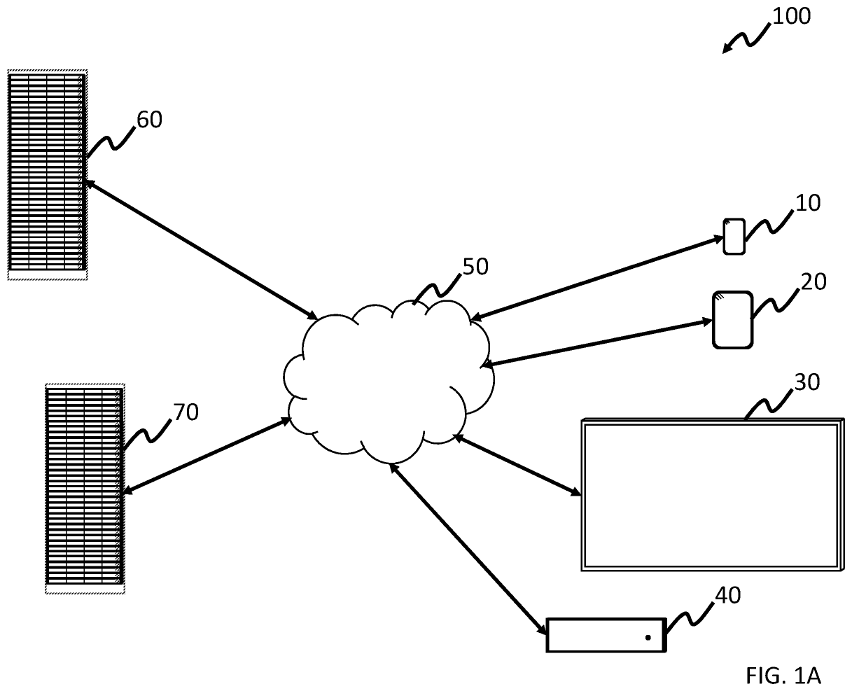

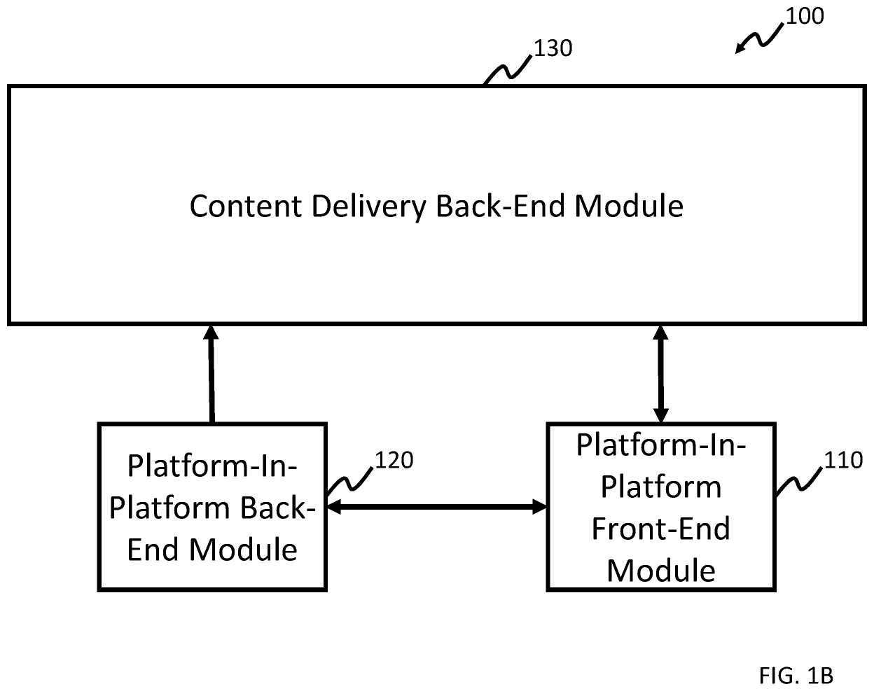

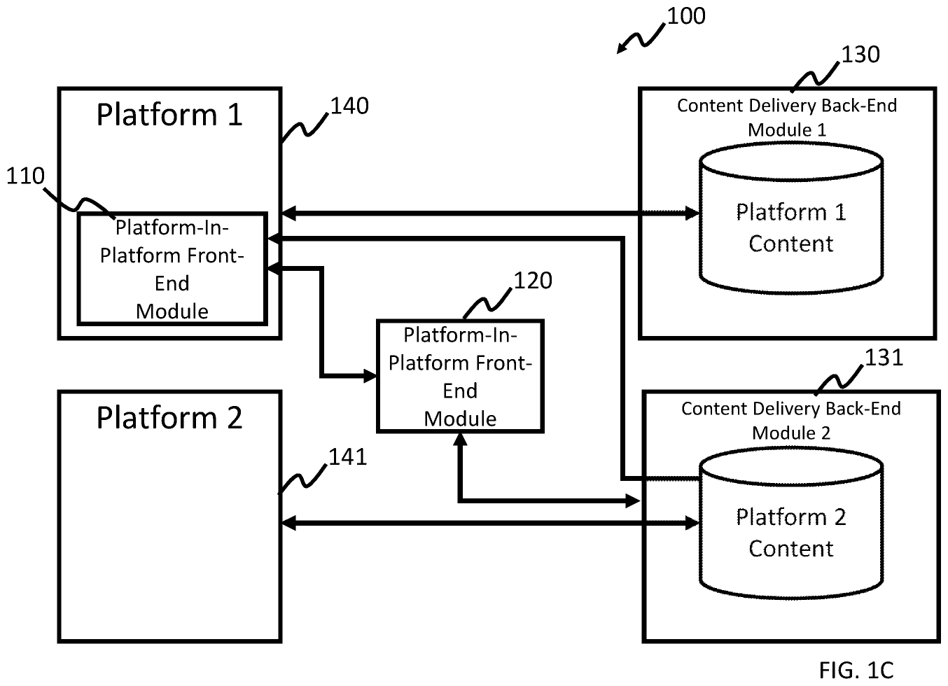

FIG. 1A depicts a PIP system, and FIG. 1B depicts a PIP system architecture according to various embodiments.

Referring to FIGS. 1A and 1B, a PIP system 100 may include electronic devices 10, 20, 30, 40 accessible by the user, a network 50, and one or more servers 60, 70. The PIP system 100 also includes a PIP front-end module 110, a PIP back-end module 120, and a content delivery back-end module 130.

In various embodiments, a PIP system 100 may be accessed by a user utilizing an electronic device 10, 20, 30, 40 connected to a network 50. As discussed above, the electronic devices 10, 20, 30 40 may be any suitable electronic device for consuming media such as audio and/or video. For example, the electronic devices may include a smart phone 10, a tablet computer 20, a television (e.g., a smart television) 30, or any other suitable set top or peripheral device 40. The network 50 may include any suitable network such as the Internet. In various embodiments, a PIP front-end module 110 may be accessed using an electronic device 10, 20, 30 40 and provide the user with an interface for interacting with the PIP system 100 (e.g., by a front-end for the PIP system 100). For example, the PIP front-end module 110 may include a graphical user interface for allowing the user to interact with the system.

In various embodiments, the PIP front-end module 110 may operate on the electronic device 10, 20, 30 40 (e.g., as an application) or may operate on a server in communication with the electronic device (e.g., via the network 50). For example, the electronic device 10, 20, 30, 40 may utilize any suitable web browser to operate the PIP front-end module 110 by utilizing the browser to access and interact with the PIP front-end module 110 operating on a remote server (e.g., as a web app).

In various embodiments, the PIP back-end module 120 and the content delivery back-end module 130 may operate on one or more servers 60, 70 in communication with the electronic devices 10, 20, 30, 40 via the network 50. The PIP back-end module 120 is configured to allow the user to utilize the PIP front-end module 110 to access content from a different platform that is stored on the content delivery back-end module 130. In various embodiments, the PIP back-end module 120 is configured to interact with both the PIP front-end module 110 and the content deliver back-end module 130. In various embodiments, the PIP back-end module 120 is configured to facilitate the registration of a user for the PIP system 100, to authenticate a user and grant access to the PIP system 100, and facilitate the streaming of media between the content delivery back-end module 130 and the PIP front-end module 110.

In various embodiments, the content delivery back-end module 130 is configured to store and distribute multimedia content. For example the content delivery back-end module 130 may be operated on one or more servers 60, 70 or on a cloud computing platform. In various embodiments, the content delivery back-end module 130 may be configured to authenticate users and stream content to user devices.

FIG. 1C depicts a PIP system architecture including multiple content platforms according to various embodiments.

Referring to FIG. 1A-1C, in various embodiments, a PIP system 100 may be configured to allow a user to access content associated with a first platform 140 and a second platform 141. In various embodiments, a first platform 140 may be configured to access content associated with the first platform 140. For example, the first platform 140 may be configured to access content stored in a first content delivery back-end module 130. Similarly, a second platform 141 may be configured to access content stored in a second content delivery back-end module 131. In various embodiments, the first platform 140 and the first content delivery back-end module 130 may be configured to operate as a first video or audio on demand service. Similarly, the second platform 141 and the second content delivery back-end module 131 may be configured to operate as a second video or audio on demand service. In various embodiments, the first platform 140 is only able to interact with the first content delivery back-end module 130 and the second platform is only able to interact with the second content delivery back-end module 131.

In various embodiments, the PIP front-end module 110 may operate as part of or be integrated into the first platform 140, and by utilizing the PIP front-end module 110, the user may access the content provided by the second content delivery back-end module 131.

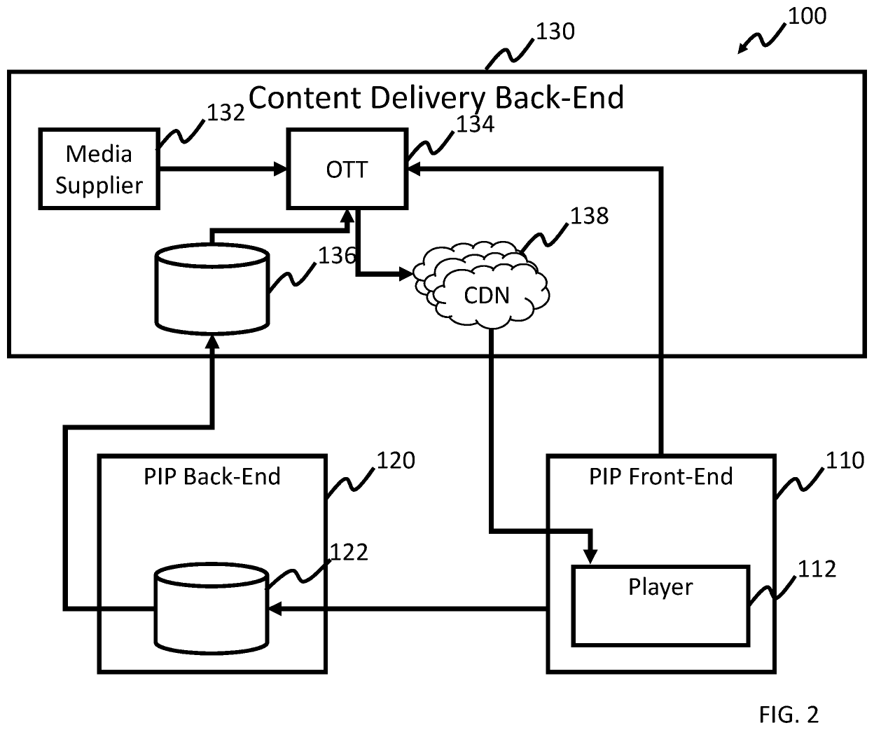

FIG. 2 is an example system architecture of a PIP system according to various embodiments of the present invention.

Referring to FIG. 2, in various embodiments, the PIP front-end module 110 may include a content player 112. In various embodiments, the content player 112 may be a web-enabled device player (e.g., a computer or tablet operating a web browser), an iOS® device player (e.g., a smart phone or tablet with iOS® operating an application), an Android® device player (e.g., a television, smart phone, or tablet operating using the Android® operating system operating an application), and an “other” device player (e.g., a web-enabled device configured for streaming such as a smart tv, media streaming device, etc. operating an application). In various embodiments, the content player 112 may be a specialized player for interacting with the PIP back-end module 120 and the content delivery backend module 130, however, in other embodiments, the content player 112 may be the same content player utilized by the platform operating the PIP front-end 110.

In various embodiments, the user may use the PIP front-end module 110 operating on a first platform being run on the user's device to access one or more additional content platforms. For example, in some instances, the user may have subscriptions to content located on one or more different content platforms. For example, the user may have one or more subscriptions that relate to different content. For example, a user may have a first subscription that includes platform 1 content that is available for playback with device(s) 10-20, a second subscription that includes platform content 2 that is available for playback with device(s) 10-30, and a third subscription that includes platform content 3 that is available for playback with device(s) 40.

As described above (and further described below), in various embodiments, the PIP front-end module 110 is configured to connect to a PIP back-end module 120 for enabling access to the content delivery back-end module 130 (e.g., a content delivery back-end module that is configured to distribute content from a different platform). In various embodiments, the PIP front-end module 110 connects to the PIP back-end module 120 and supplies the user's login credentials (e.g., either automatically or after prompting the user for the credentials) for accessing content from other platforms. The PIP back-end module 120 authenticates the user, confirms the user's subscription, and facilitates the user's access to content stored by the content delivery backend module 130 (e.g., by supplying the PIP front-end module 110 with a security token for accessing the user's selected content).

In some examples, a user may need to register for the system and/or select or purchase a subscription before logging in. In various embodiments, the user may utilize the PIP front-end module to select and purchase a new subscription.

In various embodiments, a PIP back-end module 120 may maintain a user database 122 of user accounts. The user accounts may include user login credentials, subscription information, device information, and/or any other relevant information for maintaining the user accounts. The PIP back-end module is configured to utilize the user database to authenticate users and verify their subscription to content. In various embodiments, the PIP back-end module 120 is further configured to generate session token that may be supplied to the PIP front-end module 110 to enable access to content stored on the content delivery back-end module 130.

In various embodiments, the content delivery back-end module 130 may include a content (e.g., media such as video and/or audio) supplier 132, an over-the-top media services (OTT) module 134, a client database 136, and a content distribution network 138. In various embodiments, content may be supplied by various content creator or content owners at the content supplier 132. The content delivery back-end module 130 may then store the content and the content distribution network (CDN) 138 may be used to deliver the content to the player 112. In various embodiments, the OTT module 134 may be configured to control the storage and distribution of any content. For example, the OTT module 134 may include an application programming interface (API) for interfacing with the PIP front-end 110 and/or the PIP back-end 120. The OTT module 134 may also be configured to utilize the client database 136 to authenticate access rights to content. In some embodiments, the OTT module 134 may be further configured to manage any digital rights management (DRM) that a content may have.

Although a single content platform is depicted, it should be understood that there may be any number of suitable content platforms that the PIP backend 120 may interact with.

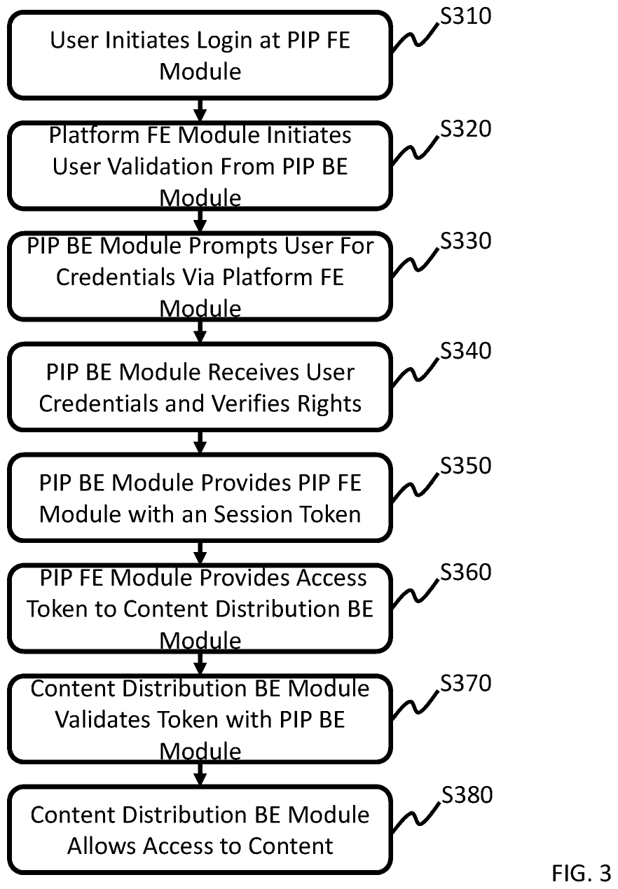

FIG. 3 is an example method of registering for a PIP system using a user platform according to various embodiments of the present invention.

Referring to FIG. 3 and with continued reference to FIG. 2, in various embodiments, a user may access a first platform using an electronic device. At some time, the user may wish to access content from a second platform without changing platforms. In various embodiments, the PIP system 100 may use a token-based system for allowing access to content. For example, the PIP back-end module 120 may be configured to generate a session token for an authorized user for use by the PIP front-end module 110. The PIP front-end module 110 may then provide the session token to the content delivery back-end 130 for accessing a content.

In various embodiments, the user may initiate the PIP system 100 by accessing the PIP front-end module 110. The PIP front-end module 110 may then begin a system login process (S310). In various embodiments, the system login process may take place upon initial use of the PIP front-end module 110 or after the user has selected to access a content available on the second platform. The PIP front-end module 110 may request a user validation from the PIP back-end module 120 (S320). In various embodiments, the PIP back-end module may verify a user's access rights (e.g., subscription) to the requested content. Thus, the PIP back-end module 120 may prompt the user for the user's credentials via the PIP front-end module 110. In some embodiments, the user may supply a security credential such as a username or password. In other embodiments, a multifactor authentication system may be used that requires the username, password, and a key supplied via an alternative system or device (e.g., SMS message, email, telephone call, a key generator etc.). In other embodiments, the PIP front-end module 110 may automatically provide the user's credentials to the PIP back-end module 120. Thus, the PIP back-end module 120 receives the user's credentials and verifies that the user has access rights (e.g., a subscription) to the desired content (S340). Upon verifying the user's access rights, the PIP back-end may supply the PIP front-end 110 with a session token (e.g., a secure token) (S350) and log the generation of and supply of the token in the database 122 (e.g., in association with the user's account). The PIP front-end module 110 may then validate the session token to the content distribution BE module 130 (S360). For example, the PIP front-end module 110 may communicate with the OTT module 134 using the OTT module's API and login using the session token. The content delivery backend module 130 may verify the authenticity of the secure token with the PIP back-end module 120 (S370). For example, the OTT module 134 may send a request to the PIP back-end module 120 that verifies the session token based on the records stored in the database 122. Once the session token has been verified, the content delivery back-end module 130 allows the login of the PIP front-end and the user may begin accessing content or a content catalog (S380). For example, the PIP front-end 110 may request the content catalog that includes an asset manifest of what multimedia content is available to the user on the content delivery back-end 130. Upon selecting a content for playback (e.g., by selecting a content and pressing the “play” button on the player 112), in various embodiments, the PIP player 112 may then request context data (e.g., metadata) for the selected media from the content delivery back-end module 130. The context data may include a signature and information that is needed to access the content (e.g., a key necessary to play content protected by DRM) and any other suitable metadata associated with the content. The player 112 may then use the signature and information that was received to request a license to view the content from the OTT module 134. Once the license has been received, the player 112 may playback the content.

In various embodiments, the PIP system 100 is also configured to allow users to subscribe to content offered on various platforms (e.g., different platforms than the platform the user is using).

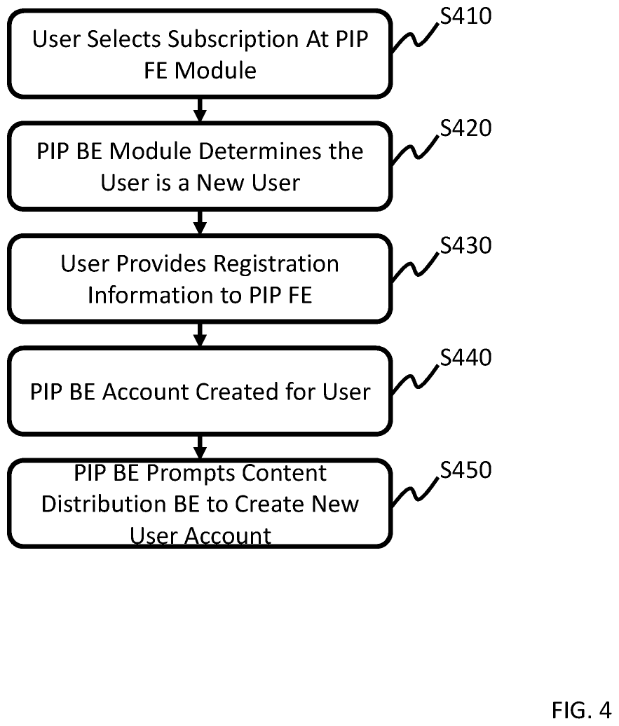

FIG. 4 is an example method of registering for a PIP system according to various embodiments of the present invention.

Referring to FIG. 4 and with continued reference to FIG. 2, in various embodiments, a user may have an account or subscription on a first platform, but may wish to expand their access to content by adding a subscription to a second content platform.

In various embodiments, a user may browse and select available subscriptions to other platforms using the PIP front-end module 110 (S410). The PIP front-end module 110 may send the user's selection to the PIP back-end module 120 for processing and registration. For example, the PIP back-end module 120 may determine if the user is a new user (S420). For example, the PIP back-end module 120 may be configured to prevent a duplicate account for a user from being generated. If the user is a new user, the PIP front-end module 110 may supply any necessary registration information to the PIP back-end module 120 (S430). In some embodiments, the PIP front-end module 110 may automatically provide the user registration information and billing information to the PIP back-end module 120. In other embodiments, the billing information may be maintained by the user's current platform. In other embodiments, the user may supply any necessary registration information via the PIP front-end module 110. The new account may then be created for the user and a household account may also be generated (S440). The user account may include an entitlement grant and/or status update (e.g., when the user upgrades a subscription to include more content or to reduce available content). In various embodiments, the PIP back-end module 120 may also prompt the content distribution back-end module 130 to generate a new account for the user (S450).

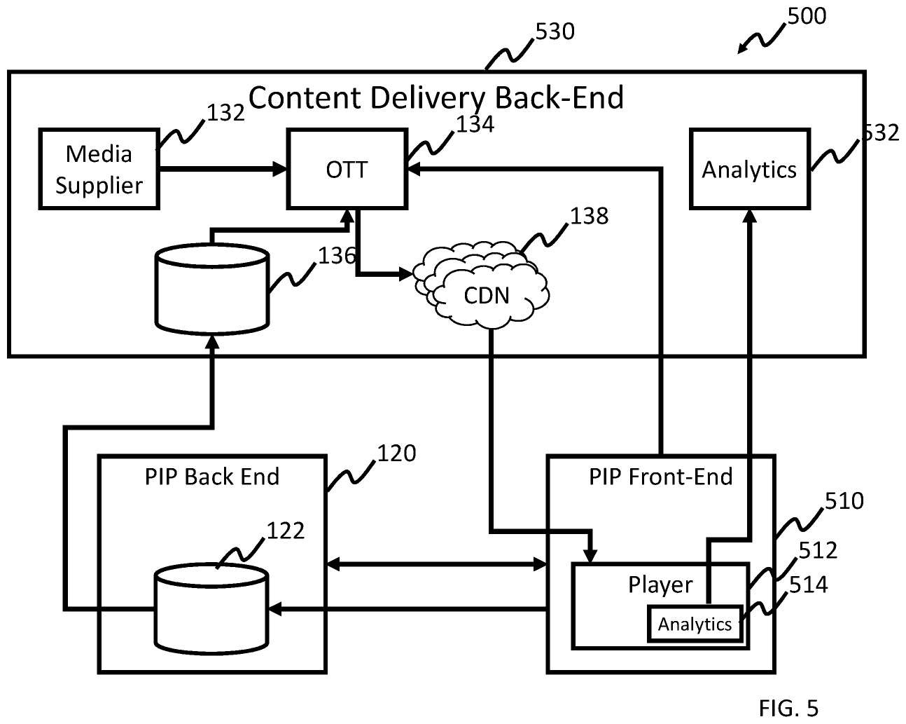

FIG. 5 is an example system architecture of a PIP system with analytics according to various embodiments of the present invention.

Referring to FIG. 5, in various embodiments, the PIP system 500 may be configured to perform data analytics on content consumption patterns. In various embodiments, the PIP system 500 includes a content delivery back-end module 530 that incorporates an analytics module 532. In various embodiments, the analytics module may be configured to track the content being delivered to users, how the content is being delivered, the quality of service being provided (e.g., how the user is experiencing the streaming service), as well as any other suitable analytics information. In various embodiments, the analytics module 532 may have an API for receiving various playback data from the PIP front-end module 510. In various embodiments, the PIP front-end module 510 may include a player 512 having a playback analytics module 514 for sending playback statistics to the analytics module 532. For example, the playback analytics module 514 may be configured to send playback statistics according to the analytics module API.

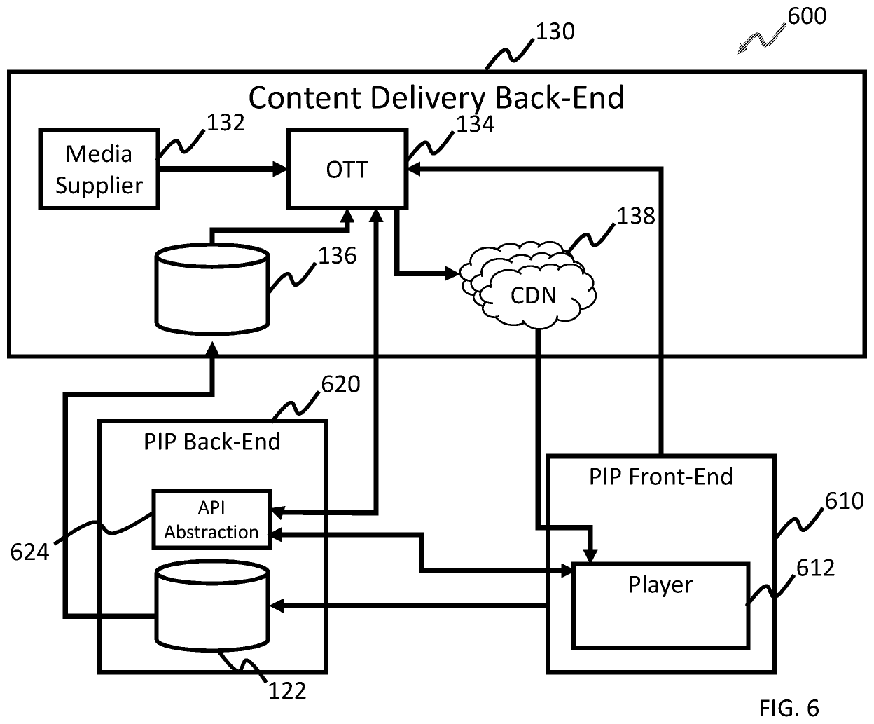

FIG. 6 is an example system architecture of a PIP system with a PIP back-end having an API abstraction layer according to various embodiments of the present invention.

Referring to FIG. 6, in various embodiments, a platform may elect to not fully modify its player for interacting with the PIP system (e.g., to reduce the number of modifications to the platform). Thus, an API abstraction layer 624 in the PIP back-end module 620 may be used to facilitate communications and content delivery between the PIP front-end module 610 and the content delivery back-end module 130. For example, the API abstraction layer 624 may be receive data from the player 612, reformat the data into the appropriate format for the OTT module 134 API, and send the data to the OTT module 134. Similarly, data from the content delivery back-end module 130 may be routed to the API abstraction layer 624 that reformats the data as necessary and sends the reformatted data to the player 612.

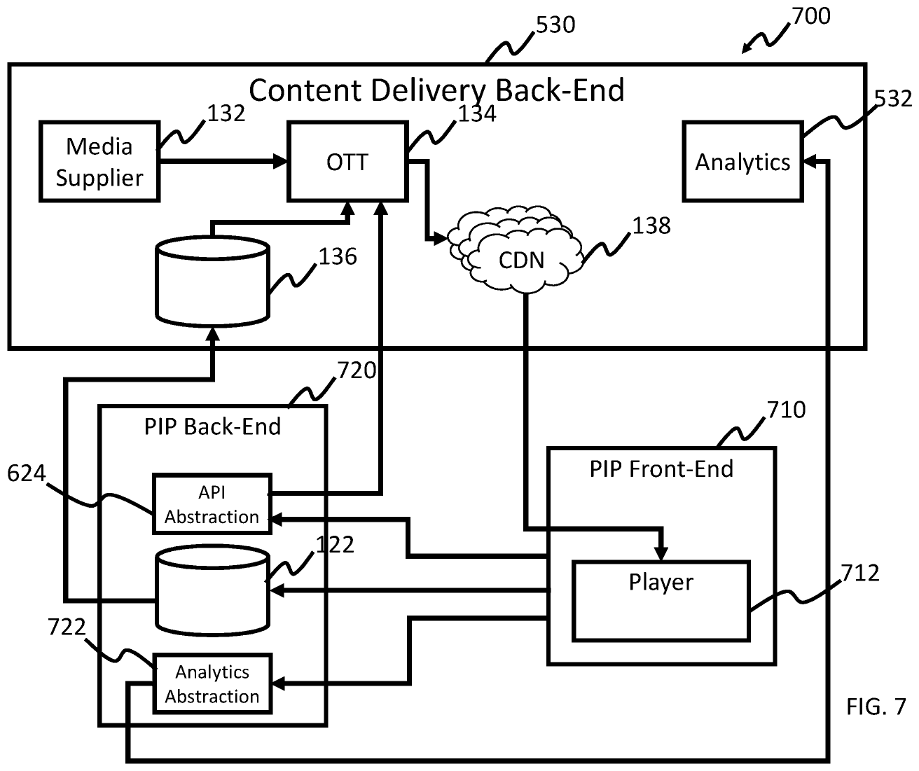

FIG. 7 is an example system architecture of a PIP system with a PIP back-end having an API abstraction layer and analytics abstraction layer according to various embodiments of the present invention.

Referring to FIG. 7, in various embodiments, the PIP system 700 may include a PIP back-end module 720 that includes an API abstraction layer 624 and an analytics abstraction layer 722. In some embodiments, it may be desirable to add the analytics module 532 to the PIP system without wanting to modify the player 712 in the PIP front-end 710. Thus, the player 712 may be configured to send any suitable analytics data to the PIP back-end 720 that modifies the analytics data to be compatible with the analytics module's 532 API. Thus, real-time analytics data may be processed.

The foregoing is illustrative of example embodiments, and is not to be construed as limiting thereof. Although a few example embodiments have been described, those skilled in the art will readily appreciate that many modifications are possible in the example embodiments without materially departing from the novel teachings and advantages of example embodiments. Accordingly, all such modifications are intended to be included within the scope of example embodiments as defined in the claims. In the claims, means-plus-function clauses are intended to cover the structures described herein as performing the recited function and not only structural equivalents but also equivalent structures. Therefore, it is to be understood that the foregoing is illustrative of example embodiments and is not to be construed as limited to the specific embodiments disclosed, and that modifications to the disclosed example embodiments, as well as other example embodiments, are intended to be included within the scope of the appended claims. The inventive concept is defined by the following claims, with equivalents of the claims to be included therein.

What is claimed is:

1. A platform-in-platform (PIP) system comprising:
a first content platform configured to operate a PIP front-end module;
a PIP back-end module configured to authenticate a user according to a user credential and generate a session token in response to authenticating the user; and
a content delivery back-end module configured to store multimedia content not available via the first content platform, wherein:
the PIP front-end module is configured to provide a user credential to the PIP back-end module, to receive the session token, and to provide the session token to the content delivery back-end module; and
the content delivery back-end module is configured to verify the session token and to allow access to the multimedia content to the PIP front-end module.

2. The PIP system of claim 1, wherein the PIP front-end module further comprises a player configured to play the multimedia content.

3. The PIP system of claim 2, wherein the PIP back-end module comprises a user database, wherein the generation of the session token is logged in the user database and wherein the content delivery back-end module is configured to verify the session token by validating the session token with the session token stored in the user database.

4. The PIP system of claim 2, wherein the content delivery back-end module further comprises an over-the-top media services (OTT) module configured to control storage and distribution of the multimedia content.

5. The PIP system of claim 4, wherein the PIP front-end module is configured to send and receive data with the OTT module according to an OTT application programming interface (API).

6. The PIP system of claim 5, wherein the PIP back-end module further comprises an API abstraction layer configured to provide an interface between the OTT module and the PIP front-end module.

7. The PIP system of claim 2, wherein the content delivery back-end module further comprises an analytics module configured to receive data associated with consumption of the multimedia content on the player.

8. The PIP system of claim 7, wherein the PIP back-end module further comprises an analytics abstraction layer configured to provide an interface between the analytics module and the player.

9. A method of providing multimedia content using a platform-in-platform (PIP) system comprising:
requesting, by a PIP back-end module, a user credential;
providing, by a PIP front-end module, the user credential;
validating, by the PIP back-end module, the user credential;
providing, by the PIP back-end module, a session token to the PIP front-end module;
providing, by the PIP front-end module, the session token to a content delivery back-end module; and
receiving, by the PIP front-end module, access to a multimedia content from the content delivery back-end module.

10. The method of claim 9, further comprising requesting, by the PIP front-end module, user validation for access to the content delivery back-end module.

11. The method of claim 9, wherein verifying the authenticity of the session token comprises validating the session token with the PIP back-end module.

12. The method of claim 9, wherein the PIP front-end module is configured to operate on a first platform and the content delivery back-end module is configured to supply multimedia content from a second platform.

13. The method of claim 12, wherein the multimedia content is not available on the first platform without use of the PIP front-end module.

14. The method of claim 9, wherein PIP front-end module further comprises a player configured to play the multimedia content.

15. The method of claim 14, wherein the content delivery back-end module further comprises an over-the-top media services (OTT) module configured to control storage and distribution of the multimedia content, the method further comprising:
sending and receiving data, by the player to the OTT module, according to an application programming interface (API) of the OTT module.

16. The method of claim 14, wherein:
the PIP backend module further comprises an API abstraction layer; and the content delivery back-end module further comprises an over-the-top media services (OTT) module configured to control storage and distribution of the multimedia content, wherein the method further comprises:
sending and receiving data, by the player, to the OTT module using the API abstraction layer.

17. The method of claim 14 , wherein the content delivery back-end module further comprises an analytics module, and the PIP back-end module further comprises an analytics abstraction layer, wherein the method further comprises:
sending analytics information from the player to the analytics module using the analytics abstraction layer.

18. The method of claim 9, further comprising, verifying, by the content delivery back-end module, an authenticity of the session token.

19. A platform-in-platform (PIP) system comprising:
a PIP front-end module configured to operate on a first platform, wherein the first platform is configured to provide access to a first multimedia content;
a PIP back-end module configured to authenticate a user according to a user credential, to generate a session token in response to authenticating the user, and to provide the session token to the PIP front-end module; and
a content delivery back-end module configured to provide access to a second multimedia content associated with a second platform, wherein:
the PIP front-end module is configured to access and play the second multimedia content by providing the session token to the content delivery back-end module.

20. The PIP system of claim 19, wherein the PIP front-end module is further configured to provide a user credential to the PIP back-end module and to receive the session token.

21. The PIP system of claim 20, wherein the content delivery back-end module is configured to provide access to the second multimedia content by the PIP front-end module when the session token is validated by the PIP back-end module.
